(19) United States
(12) Patent Application Publication
(10) Pub. No.: US 2026/0352663 A1
(43) Pub. Date: Nov. 5, 2026

(54) Email Spoof Detection and Remediation Using Allowlists

(71) Applicant: Sophos Limited, Abingdon Oxfordshire (GB)

(72) Inventors: Rahul SINHA, Ahmedabad (IN); John MEARS, Abingdon (GB); Balakrishnan RAJKUMAR, Chennai (IN)

(73) Assignee: Sophos Limited, Abingdon Oxfordshire (GB)

(21) Appl. No.: 19/289,414

(22) Filed: Aug. 4, 2025

(30) Foreign Application Priority Data
Apr. 30, 2025 (IN) 202511041988

(51) Int. Cl. H04L 9/40; H04L 51/212

(52) U.S. Cl. CPC H04L 63/101; H04L 51/212; H04L 63/1416; H04L 63/1441; H04L 63/20

(57) ABSTRACT

A computer-implemented method includes receiving an email for processing where the email message includes a sender header address and a sender envelope address. The method further includes responsive to determining that the sender header address is on an allowlist associated with the recipient, determining whether a sender envelope domain associated with the sender envelope address is on the allowlist. The method further includes responsive to determining that the sender envelope domain is not on the allowlist, providing the email message to one or more scanners to detect whether the email message includes suspicious content. The method further includes responsive to no suspicious content being detected, delivering the email message to the recipient.

### CROSS-REFERENCE TO RELATED APPLICATIONS

This application claims priority to Indian Patent Application No. 202511041988, entitled, “Email Spoof Detection and Remediation Using Allowlists,” filed Apr. 30, 2025, which is incorporated herein by reference in its entirety.

### FIELD

Embodiments relate generally to modifying a sender determining whether to deliver email messages. More particularly, embodiments relate to methods, systems, and computer-readable media that deliver an email message based on whether a sender header address and a sender envelope domain are on an allowlist.

### BACKGROUND

Every email message has two from addresses: an envelope from (i.e., a sender envelope address) and a header from (i.e., a sender header address). The envelope from is the address specified by the mail from command during a Simple Mail Transfer Protocol (SMTP) transaction. The header from address is the address specified in the from header field in the data command.

The sender envelope address and the sender header address may be different addresses. For example, a forwarding service may send out email messages on behalf of a sender, resulting in the addresses being different. Furthermore, sender envelope addresses are not meant to be viewed by email recipients and often include gibberish in the address.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method includes receiving an email message addressed to a recipient, wherein the email message includes a sender header address and a sender envelope address. The method further includes responsive to determining that the sender header address is on an allowlist associated with the recipient, determining whether a sender envelope domain associated with the sender envelope address is on the allowlist. The method further includes responsive to determining that the sender envelope domain is not on the allowlist, providing the email message to one or more scanners to detect whether the email message includes suspicious content. The method further includes responsive to no suspicious content being detected, delivering the email message to the recipient.

In some embodiments, the method further includes responsive to delivering the email message, determining whether the recipient requested to add the sender header address to the allowlist and responsive to determining that the recipient requested to add the sender header address to the allowlist, determining whether the sender envelope domain is on the allowlist. In some embodiments, the method further includes responsive to determining that the sender envelope domain is not on the allowlist, adding the sender envelope domain to the allowlist. In some embodiments, the method further includes responsive to the sender envelope domain being on the allowlist, performing a Sender Policy Framework (SPF) check on the email message, wherein delivering the email message to the recipient is performed only if the SPF check passes. In some embodiments, the method further includes responsive to the sender envelope domain being on the allowlist, performing an SPF check on the email message and responsive to the SPF check not passing, performing an action selected from a group of quarantining the email message, delivering the email message to a sandbox, notifying an administrator that the email message has the suspicious content, removing an attachment from the email message, filtering the suspicious content, redacting the suspicious content, and combinations thereof.

In some embodiments, the method further includes responsive to suspicious content being detected, performing a protective action selected from a group of quarantining the email message, delivering the email message to a sandbox, notifying an administrator that the email message has the suspicious content, removing an attachment from the email message, filtering the suspicious content, redacting the suspicious content, and combinations thereof. In some embodiments, the email message is further addressed to a second recipient and the method further includes determining that the email message is trusted by the second recipient based on the sender header address being on a second allowlist associated with the second recipient and the sender envelope domain associated with the sender envelope address being on the second allowlist and responsive to determining that the email message is trusted by the second recipient, delivering the email message to the second recipient. In some embodiments, the method further includes providing a user interface to the recipient to add the sender envelope domain to the allowlist.

A device comprises one or more processors and one or more computer-readable media, coupled to the one or more processors and having instructions stored thereon that, when executed by the one or more processors, cause the one or more processors to perform operations. The operations include receiving an email message addressed to a recipient, wherein the email message includes a sender header address and a sender envelope address; responsive to determining that the sender header address is on an allowlist associated with the recipient, determining whether a sender envelope domain associated with the sender envelope address is on the allowlist; responsive to determining that the sender envelope domain is not on the allowlist, providing the email message to one or more scanners to detect whether the email message includes suspicious content; and responsive to no suspicious content being detected, delivering the email message to the recipient.

In some embodiments, the operations further include responsive to delivering the email message, determining whether the recipient requested to add the sender header address to the allowlist and responsive to determining that the recipient requested to add the sender header address to the allowlist, determining whether the sender envelope domain is on the allowlist. In some embodiments, the operations further include responsive to determining that the sender envelope domain is not on the allowlist, adding the sender envelope domain to the allowlist. In some embodiments, the operations further include responsive to the sender envelope domain being on the allowlist, performing an SPF check on the email message, wherein delivering the email message to the recipient is performed only if the SPF check passes. In some embodiments, the operations further include responsive to the sender envelope domain being on the allowlist, performing an SPF check on the email message and responsive to the SPF check not passing, performing an action selected from a group of quarantining the email message, delivering the email message to a sandbox, notifying an administrator that the email message has the suspicious content, removing an attachment from the email message, filtering the suspicious content, redacting the suspicious content, and combinations thereof. In some embodiments, the operations further include responsive to suspicious content being detected, performing a protective action selected from a group of quarantining the email message, delivering the email message to a sandbox, notifying an administrator that the email message has the suspicious content, removing an attachment from the email message, filtering the suspicious content, redacting the suspicious content, and combinations thereof. In some embodiments, the email message is further addressed to a second recipient and the operations further include determining that the email message is trusted by the second recipient based on the sender header address being on a second allowlist associated with the second recipient and the sender envelope domain associated with the sender envelope address being on the second allowlist and responsive to determining that the email message is trusted by the second recipient, delivering the email message to the second recipient.

A non-transitory computer-readable medium with instructions stored thereon that, responsive to execution by a processing device, causes the processing device to perform operations. The operations include receiving an email message addressed to a recipient, wherein the email message includes a sender header address and a sender envelope address; responsive to determining that the sender header address is on an allowlist associated with the recipient, determining whether a sender envelope domain associated with the sender envelope address is on the allowlist; responsive to determining that the sender envelope domain is not on the allowlist, providing the email message to one or more scanners to detect whether the email message includes suspicious content; and responsive to no suspicious content being detected, delivering the email message to the recipient.

In some embodiments, the operations further include responsive to delivering the email message, determining whether the recipient requested to add the sender header address to the allowlist and responsive to determining that the recipient requested to add the sender header address to the allowlist, determining whether the sender envelope domain is on the allowlist. In some embodiments, the operations further include responsive to determining that the sender envelope domain is not on the allowlist, adding the sender envelope domain to the allowlist. In some embodiments, the operations further include responsive to the sender envelope domain being on the allowlist, performing an SPF check on the email message, wherein delivering the email message to the recipient is performed only if the SPF check passes. In some embodiments, the operations further include responsive to the sender envelope domain being on the allowlist, performing an SPF check on the email message and responsive to the SPF check not passing, performing an action selected from a group of quarantining the email message, delivering the email message to a sandbox, notifying an administrator that the email message has the suspicious content, removing an attachment from the email message, filtering the suspicious content, redacting the suspicious content, and combinations thereof.

### BRIEF DESCRIPTION OF THE DRAWINGS

FIG. 1 depicts a block diagram of a threat management system, according to some embodiments described herein.

FIG. 2 is a block diagram of a threat management system that includes a cloud enterprise facility, according to some embodiments described herein.

FIG. 3 is a block diagram of a system for enterprise network threat detection, according to some embodiments described herein.

FIG. 4 is an example computing device, according to some embodiments described herein.

FIG. 5 illustrates an example of different types of information that are part of an email message, according to some embodiments described herein.

FIG. 6 illustrates an example user interface of an allowlist and blocklist that includes addresses, according to some embodiments described herein.

FIG. 7 is an example user interface to add a sender header address to the allowlist illustrated in FIG. 6, according to some embodiments described herein.

FIG. 8 is an example user interface to add a sender header address and one or more sender email domains to the allowlist illustrated in FIG. 6, according to some embodiments described herein.

FIGS. 9A-9B are a flow diagram of an example method to determine whether to deliver an email message, according to some embodiments described herein.

FIG. 10 is a flow diagram of an example method to selectively deliver an email message to a recipient, according to some embodiments described herein.

### DETAILED DESCRIPTION

### Overview

A security application receives email messages and determines whether the email messages are safe to deliver to recipients. The security application uses different authentication mechanisms to verify the safety of the email messages. Sender Policy Framework (SPF) is a mechanism that checks whether an email message claiming to come from a specific domain is from an Internet Protocol (IP) address authorized by that domain's administrator.

The security application extracts the domain name from the sender envelope address and checks the IP address to determine if the IP address is listed in the SPF record for the sender envelope domain published in the Domain Name System (DNS). If the IP address for the sender envelope domain is listed in the SPF record, the security application delivers the email message.

The SPF record does not use the sender header address for authentication because the sender header address may be spoofed by attackers trying to convince recipients that an email message is safe, when instead the email message includes suspicious content. For example, an attacker may spoof the sender header address to appear as if an email message is from a package delivery service to entice a user to click on a link in the email message that is associated with malicious content.

Traditional security applications allow recipients to add senders listed on the sender header address to an allowlist. A problem arises when the sender header address is different from the sender envelope address. This may occur if the email address is sent by a forwarding service that is associated with a different domain than the sender of the email message, by a mass-mailing service, by a different group at the company that sends out a certain kind of email message, etc. If the sender header address is different from the sender envelope address and the sender envelope address is not on the allowlist, the email message may not be delivered, which results in a bad user experience. The recipient may again authorize the sender, but if the sender header address is again different from the sender envelope address, the email message may not be delivered, which continues the poor user experience.

The security application as described herein advantageously adds a sender envelope domain to the allowlist in associated with the sender header address to enable delivery of email messages where the sender header address and the sender envelope domain are different. The security application advantageously adds the sender envelope domain instead of the sender envelope address because sender envelope addresses can change from one email to another, while still having the same domain. In some embodiments, the security application generates a user interface that enables the user to add the sender envelope domain to the allowlist.

The security application as described herein includes multiple mechanisms for ensuring that the email message is safe for delivery. For example, if the sender header address is on the allowlist, but the sender envelope domain is not on the allowlist, the security application may scan the email message for suspicious content and, if not suspicious content is found, delivers the email message. This advantageously balances the need of maintaining security while improving the user experience since genuine and secure email messages are delivered, not blocked. In addition, the changes are made by the security application and do not modify the SPF check that is conventionally performed.

### Threat Management System

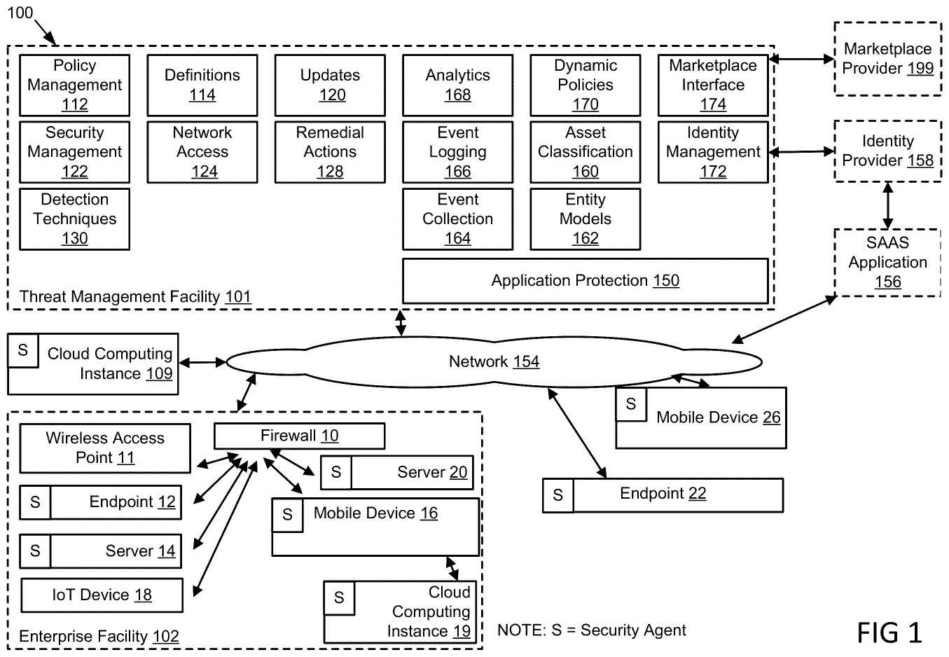

FIG. 1 depicts a block diagram of a threat management system 100 providing protection against a plurality of threats, such as malware, viruses, spyware, cryptoware, adware, Trojans, spam, intrusion, policy abuse, improper configuration, vulnerabilities, improper access, uncontrolled access, and more. A threat management facility 101 may communicate with, coordinate, and control operation of security functionality at different control points, layers, and levels within the system 100. A number of capabilities may be provided by a threat management facility 101, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats. In embodiments, the threat management facility 101 may provide protection from a variety of threats to a variety of compute instances in a variety of locations and network configurations.

As one example, users of the threat management facility 101 may define and enforce policies that control access to and use of compute instances, networks and data. Administrators may update policies such as by designating authorized users and conditions for use and access. The threat management facility 101 may update and enforce those policies at various levels of control that are available, such as by directing compute instances to control the network traffic that is allowed to traverse firewalls and wireless access points, applications and data available from servers, applications and data permitted to be accessed by endpoints, and network resources and data permitted to be run and used by endpoints. The threat management facility 101 may provide many different services, and policy management may be offered as one of the services.

Turning to a description of certain capabilities and components of the threat management system 100, an exemplary enterprise facility 102 may be or may include any networked computer-based infrastructure. For example, the enterprise facility 102 may be corporate, commercial, organizational, educational, governmental, or the like. As home networks get more complicated, and include more compute instances at home and in the cloud, an enterprise facility 102 may also or instead include a personal network such as a home or a group of homes. The enterprise facility's 102 computer network may be distributed amongst a plurality of physical premises such as buildings on a campus, and located in one or in a plurality of geographical locations. The configuration of the enterprise facility as shown is merely exemplary, and it will be understood that there may be any number of compute instances, less or more of each type of compute instances, and other types of compute instances. As shown, the exemplary enterprise facility includes a firewall 10, a wireless access point 11, an endpoint 12, a server 14, a mobile device 16, an appliance or IOT device 18, a cloud computing instance 19, and a server 20. Again, the compute instances 10-20 depicted are exemplary, and there may be any number or types of compute instances 10-20 in a given enterprise facility. For example, in addition to the elements depicted in the enterprise facility 102, there may be one or more gateways, bridges, wired networks, wireless networks, virtual private networks, other compute instances, and so on.

The threat management facility 101 may include certain facilities, such as a policy management facility 112, security management facility 122, update facility 120, definitions facility 114, network access rules facility 124, remedial action facility 128, detection techniques facility 130, application protection facility 150, asset classification facility 160, entity model facility 162, event collection facility 164, event logging facility 166, analytics facility 168, dynamic policies facility 170, identity management facility 172, and marketplace management facility 174, as well as other facilities. For example, there may be a testing facility, a threat research facility, and other facilities. It should be understood that the threat management facility 101 may be implemented in whole or in part on a number of different compute instances, with some parts of the threat management facility on different compute instances in different locations. For example, some or all of one or more of the various facilities 100, 112-174 may be provided as part of a security agent S that is included in software running on a compute instance 10-26 within the enterprise facility. Some or all of one or more of the facilities 100, 112-174 may be provided on the same physical hardware or logical resource as a gateway, such as a firewall 10, or wireless access point 11. Some or all of one or more of the facilities may be provided on one or more cloud servers that are operated by the enterprise or by a security service provider, such as the cloud computing instance 109.

In embodiments, a marketplace provider 199 may make available one or more additional facilities to the enterprise facility 102 via the threat management facility 101. The marketplace provider may communicate with the threat management facility 101 via the marketplace interface facility 174 to provide additional functionality or capabilities to the threat management facility 101 and compute instances 10-26. As non-limiting examples, the marketplace provider 199 may be a third-party information provider, such as a physical security event provider; the marketplace provider 199 may be a system provider, such as a human resources system provider or a fraud detection system provider; the marketplace provider may be a specialized analytics provider; and so on. The marketplace provider 199, with appropriate permissions and authorization, may receive and send events, observations, inferences, controls, convictions, policy violations, or other information to the threat management facility. For example, the marketplace provider 199 may subscribe to and receive certain events, and in response, based on the received events and other events available to the marketplace provider 199, send inferences to the marketplace interface, and in turn to the analytics facility 168, which in turn may be used by the security management facility 122.

The identity provider 158 may be any remote identity management system or the like configured to communicate with an identity management facility 172, e.g., to confirm identity of a user as well as provide or receive other information about users that may be useful to protect against threats. In general, the identity provider may be any system or entity that creates, maintains, and manages identity information for principals while providing authentication services to relying party applications, e.g., within a federation or distributed network. The identity provider may, for example, offer user authentication as a service, where other applications, such as web applications, outsource the user authentication step to a trusted identity provider.

In embodiments, the identity provider 158 may provide user identity information, such as multi-factor authentication, to a SaaS application. Centralized identity providers such as Microsoft Azure, may be used by an enterprise facility instead of maintaining separate identity information for each application or group of applications, and as a centralized point for integrating multifactor authentication. In embodiments, the identity management facility 172 may communicate hygiene, or security risk information, to the identity provider 158. The identity management facility 172 may determine a risk score for a user based on the events, observations, and inferences about that user and the compute instances associated with the user. If a user is perceived as risky, the identity management facility 172 can inform the identity provider 158, and the identity provider 158 may take steps to address the potential risk, such as to confirm the identity of the user, confirm that the user has approved the SaaS application access, remediate the user's system, or such other steps as may be useful.

In embodiments, threat protection provided by the threat management facility 101 may extend beyond the network boundaries of the enterprise facility 102 to include clients (or client facilities) such as an endpoint 22 outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22, 26 use a network that is outside of the enterprise facility 102 and separated from the enterprise facility 102, e.g., by a gateway, a public network, and so forth.

In some implementations, compute instances 10-26 may communicate with cloud applications, such as a SaaS application 156. The SaaS application 156 may be an application that is used by but not operated by the enterprise facility 102. Exemplary commercially available SaaS applications 156 include Salesforce, Amazon Web Services (AWS) applications, Google Apps applications, Microsoft Office 365 applications and so on. A given SaaS application 156 may communicate with an identity provider 158 to verify user identity consistent with the requirements of the enterprise facility 102. The compute instances 10-26 may communicate with an unprotected server 188 such as a web site or a third-party application through an internetwork 154 such as the Internet or any other public network, private network, or combination of these.

In embodiments, aspects of the threat management facility 101 may be provided as a stand-alone solution. In other embodiments, aspects of the threat management facility 101 may be integrated into a third-party product. An application programming interface (e.g. a source code interface) may be provided such that aspects of the threat management facility 101 may be integrated into or used by or with other applications. For instance, the threat management facility 101 may be stand-alone in that it provides direct threat protection to an enterprise or computer resource, where protection is subscribed to directly 100. Alternatively, the threat management facility may offer protection indirectly, through a third-party product, where an enterprise may subscribe to services through the third-party product, and threat protection to the enterprise may be provided by the threat management facility 101 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In embodiments, the scanning may include scanning some or all files on a periodic basis, scanning an application when the application is executed, scanning data transmitted to or from a device, scanning email messages and accompanying attachments (if any), scanning in response to predetermined actions or combinations of actions, and so forth. The scanning of applications, email messages, files, and data may be performed to detect known or unknown malicious code or unwanted applications. Aspects of the malicious code protection may be provided, for example, in the security agent of an endpoint 12, in a wireless access point 11 or firewall 10, as part of application protection 150 provided by the cloud, and so on.

In an embodiment, the security management facility 122 may provide for email security and control, for example to target spam, viruses, spyware, and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 150 provided by the cloud, and so on.

In some embodiments, the email security and control provided by the security management facility 122 includes determining whether email messages include a sender header address that is on an allowlist, determining whether a sender envelope domain associated with the sender envelope address is on the allowlist, and performing additional actions depending on the determinations. For example, if the sender envelope domain is not on the allowlist, the security management facility 122 may scan the email message to detect whether the email message includes suspicious content.

In an embodiment, security management facility 122 may provide for web security and control, for example, to detect or block viruses, spyware, malware, unwanted applications, help control web browsing, and the like, which may provide comprehensive web access control enabling safe, productive web browsing. Web security and control may provide Internet use policies, reporting on suspect compute instances, security and content filtering, active monitoring of network traffic, URI filtering, and the like. Aspects of the web security and control may be provided, for example, in the security agent of an endpoint 12, in a wireless access point 11 or firewall 10, as part of application protection 150 provided by the cloud, and so on.

In an embodiment, the security management facility 122 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In embodiments, a VPN may be treated in the same manner as a physical network. Aspects of network access control may be provided, for example, in the security agent of an endpoint 12, in a wireless access point 11 or firewall 10, as part of application protection 150 provided by the cloud, e.g., from the threat management facility 101 or other network resource(s).

In an embodiment, the security management facility 122 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 150 provided by the cloud, and so on.

In an embodiment, the security management facility 122 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 101. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of application protection 150 provided by the cloud, and so on. In embodiments, some reputation information may be stored on a compute instance 10-26, and other reputation data available through cloud lookups to an application protection lookup database, such as may be provided by application protection 150.

In embodiments, information may be sent from the enterprise facility 102 to a third party, such as a security vendor, or the like, which may lead to improved performance of the threat management facility 101. In general, feedback may be useful for any aspect of threat detection. For example, the types, times, and number of virus interactions that an enterprise facility 102 experiences may provide useful information for the preventions of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

An update management facility 120 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In embodiments, updates may be provided to the enterprise facility's 102 network, where one or more compute instances on the enterprise facility's 102 network may distribute updates to other compute instances.

The threat management facility 101 may include a policy management facility 112 that manages rules or policies for the enterprise facility 102. Exemplary rules include access permissions associated with networks, applications, compute instances, users, content, data, and the like. The policy management facility 112 may use a database, a text file, other data store, or a combination to store policies. In an embodiment, a policy database may include a blocklist and an allowlist, and more. As a few non-limiting examples, policies may include a list of enterprise facility 102 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. Exemplary policies may be defined for an enterprise facility, application type, subset of application capabilities, organization hierarchy, compute instance type, user type, network location, time of day, connection type, or any other suitable definition. Policies may be maintained through the threat management facility 101, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In an embodiment, the policy management facility 112 may be a stand-alone application, may be part of the network server facility 142, may be part of the enterprise facility 102 network, may be part of the client facility, or any suitable combination of these.

The policy management facility 112 may include dynamic policies that use contextual or other information to make security decisions. As described herein, the dynamic policies facility 170 may generate policies dynamically based on observations and inferences made by the analytics facility. The dynamic policies generated by the dynamic policy facility 170 may be provided by the policy management facility 112 to the security management facility 122 for enforcement.

In embodiments, the threat management facility 101 may provide configuration management as an aspect of the policy management facility 112, the security management facility 122, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of USB disks, and policy management 112 may require a configuration that turns off USB drive access via a registry key of a compute instance. Aspects of configuration management may be provided, for example, in the security agent of an endpoint 12, in a wireless access point 11 or firewall 10, as part of application protection 150 provided by the cloud, or any combination of these.

In embodiments, the threat management facility 101 may also provide for the isolation or removal of certain applications that are not desired or may interfere with the operation of a compute instance 10-26 or the threat management facility 101, even if such application is not malware per se. The operation of such products may be considered a configuration violation. The removal of such products may be initiated automatically whenever such products are detected, or access to data and network resources may be restricted when they are installed and running. In the case where such applications are services which are provided indirectly through a third-party product, the applicable application or processes may be suspended until action is taken to remove or disable the third-party product.

The policy management facility 112 may also require update management (e.g., as provided by the update facility 120). Update management for the security facility 122 and policy management facility 112 may be provided directly by the threat management facility 101, or, for example, by a hosted system. In embodiments, the threat management facility 101 may also provide for patch management, where a patch may be an update to an operating system, an application, a system tool, or the like, where one of the reasons for the patch is to reduce vulnerability to threats.

In embodiments, the security facility 122 and policy management facility 112 may push information to the enterprise facility 102 network and/or the compute instances 10-26, the enterprise facility 102 network and/or compute instances 10-26 may pull information from the security facility 122 and policy management facility 112, or there may be a combination of pushing and pulling of information. For example, the enterprise facility 102 network and/or compute instances 10-26 may pull update information from the security facility 122 and policy management facility 112 via the update facility 120, an update request may be based on a time period, by a certain time, by a date, on demand, or the like. In another example, the security facility 122 and policy management facility 112 may push the information to the enterprise facility's 102 network and/or compute instances 10-26 by providing notification that there are updates available for download and/or transmitting the information. In an embodiment, the policy management facility 112 and the security facility 122 may work in concert with the update management facility 120 to provide information to the enterprise facility's 102 network and/or compute instances 10-26. In various embodiments, policy updates, security updates and other updates may be provided by the same or different modules, which may be the same or separate from a security agent running on one of the compute instances 10-26.

As threats are identified and characterized, the definition facility 114 of the threat management facility 101 may manage definitions used to detect and remediate threats. For example, identity definitions may be used for scanning files, applications, data streams, etc. for the determination of malicious code. Identity definitions may include instructions and data that can be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In embodiments, the threat management facility 101 and the compute instances 10-26 may be provided with new definitions periodically to include most recent threats. Updating of definitions may be managed by the update facility 120, and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 101 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 101 may control access to the enterprise facility 102 networks. A network access facility 124 may restrict access to certain applications, networks, files, printers, servers, databases, and so on. In addition, the network access facility 124 may restrict user access under certain conditions, such as the user's location, usage history, need to know, job position, connection type, time of day, method of authentication, client-system configuration, or the like. Network access policies may be provided by the policy management facility 112, and may be developed by the enterprise facility 102, or pre-packaged by a supplier. Network access facility 124 may determine if a given compute instance 10-22 should be granted access to a requested network location, e.g., inside or outside of the enterprise facility 102. Network access facility 124 may determine if a compute instance 22, 26 such as a device outside the enterprise facility 102 may access the enterprise facility 102. For example, in some cases, the policies may require that when certain policy violations are detected, certain network access is denied. The network access facility 124 may communicate remedial actions that are necessary or helpful to bring a device back into compliance with policy as described below with respect to the remedial action facility 128. Aspects of the network access facility 124 may be provided, for example, in the security agent of the endpoint 12, in a wireless access point 11, in a firewall 10, as part of application protection 150 provided by the cloud, and so on.

In an embodiment, the network access facility 124 may have access to policies that include one or more of a blocklist, an allowlist,, an unacceptable network site database, an acceptable network site database, a network site reputation database, or the like of network access locations that may or may not be accessed by the client facility. Additionally, the network access facility 124 may use rule evaluation to parse network access requests and apply policies. The network access rule facility 124 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 101 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, MacOS, Linux, Android, iOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility may include entity models 162. The entity models may be used, for example, to determine the events that are generated by assets. For example, some operating systems may provide useful information for detecting or identifying events. For examples, operating systems may provide process and usage information that accessed through an API. As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection facility 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19, 109. Events may range in granularity. An exemplary event may be communication of a specific packet over the network. Another exemplary event may be identification of an application that is communicating over a network.

The event logging facility 166 may be used to store events collected by the event collection facility 164. The event logging facility 166 may store collected events so that they can be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility Observations or inferences about events may also be logged by the event logging facility 166.

When a threat or other policy violation is detected by the security management facility 122, the remedial action facility 128 may be used to remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 122 may take any steps or deploy any measures suitable for addressing a detection of a threat, potential threat, policy violation or other event, code or activity that might compromise security of a computing instance 10-26 or the enterprise facility 102.

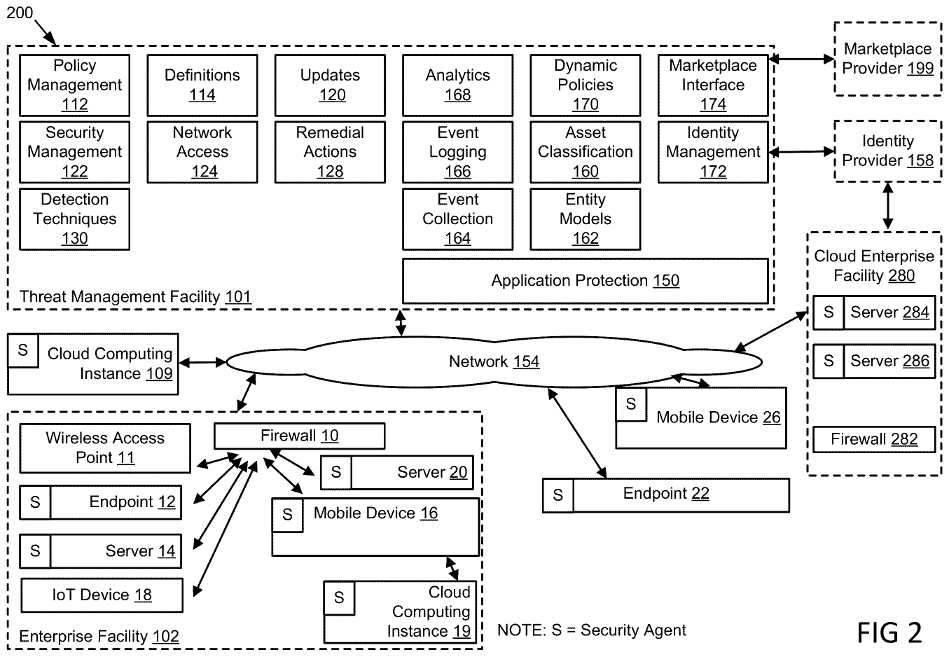

FIG. 2 depicts a block diagram of a threat management system 201 such as any of the threat management systems described herein, and including a cloud enterprise facility 280. The cloud enterprise facility 280 may include servers 284, 286, and a firewall 282. The servers 284, 286 on the cloud enterprise facility 280 may run one or more enterprise applications and make them available to the enterprise facilities 102 compute instances 10-26. It should be understood that there may be any number of servers 284, 286 and firewalls 282, as well as other compute instances in a given cloud enterprise facility 280. It also should be understood that a given enterprise facility may use both SaaS applications 156 and cloud enterprise facilities 280, or, for example, a SaaS application 156 may be deployed on a cloud enterprise facility 280. As such, the configurations in FIG. 1 and FIG. 2 are shown by way of examples and not exclusive alternatives.

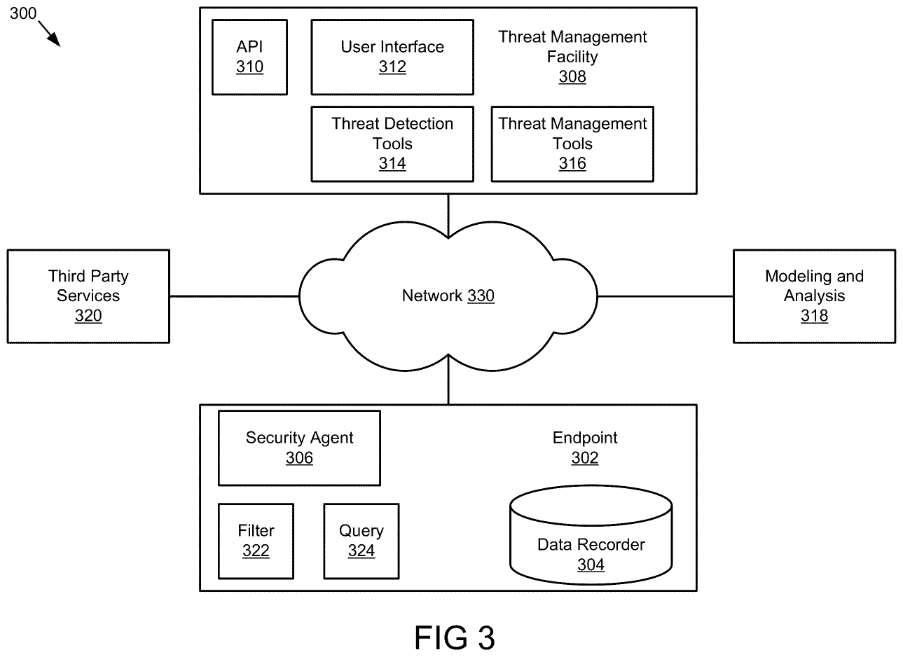

FIG. 3 shows a system 300 for enterprise network threat detection, in accordance with some embodiments. System 300 includes one or more endpoints 302, one or more threat management facilities 308, a modeling and analysis platform 318, and third party services 320, all coupled via a network 330. In various embodiments, endpoint 302 may include a security agent 306, a filter 322, and a query interface 324. Endpoint 302 may also include a data recorded 304. Threat management facility 308 may include an application programming interface (API) 310, a user interface 312, one or more threat detection tools 314, and one or more threat management tools 316. The system 300 may use any of the various tools and techniques for threat management contemplated herein.

Endpoints such as the endpoint 302 may log events in a data recorder 304. A local agent on the endpoint 302 such as the security agent 306 may filter this data and feed a filtered data stream to the threat management facility 308, such as a central threat management facility or any of the other threat management facilities described herein.

The threat management facility 308 can locally or globally tune filtering by local agents based on the current data stream, and can query local event data recorders for additional information where necessary or helpful in threat detection or forensic analysis. The threat management facility 308 may also or instead store and deploys a number of security tools such as a web-based user interface that is supported by machine learning models to aid in the identification and assessment of potential threats by a human user. This may, for example, include machine learning analysis of new code samples, models to provide human-readable context for evaluating potential threats, and any of the other tools or techniques described herein. More generally, the threat management facility 308 may provide any of threat management tools 316 to aid in the detection, evaluation, and remediation of threats or potential threats.

The threat management facility 308 may perform a range of threat management functions such as any of those described herein including determining whether a sender header address of an email message is on an allowlist associated with a recipient of the email message. The threat management facility 308 may generally include the application programming interface 310, which is usable to communicate with the third party services 320. In some embodiments, the threat management facility may include the user interface 312 for access to threat management and network administration functions, and the threat detection tools 314.

In general, the application programming interface 310 may support programmatic connections with third party services 320. The application programming interface 310 may, for example, connect to Active Directory or other customer information about applications stored on email messages, files, data storage, identities and user profiles, roles, access privileges and so forth. More generally the application programming interface 310 may provide a programmatic interface for customer or other third party context, information, administration and security tools, and so forth. The application programming interface 310 may also or instead provide a programmatic interface for hosted applications, identity provider integration tools or services, and so forth.

The user interface 312 may include a website or other graphical user interface (GUI) or the like, and may generally provide an interface for user interaction with the threat management facility 308, e.g., for threat detection, network administration, audit, configuration and so forth. This user interface 312 may generally facilitate human curation of intermediate threats as contemplated herein, e.g., by presenting intermediate threats along with other supplemental information, and providing controls for user to dispose of such intermediate threats as desired, e.g., by permitting execution or access, by denying execution or access, or by engaging in remedial measures such as sandboxing, quarantining, vaccinating, and so forth.

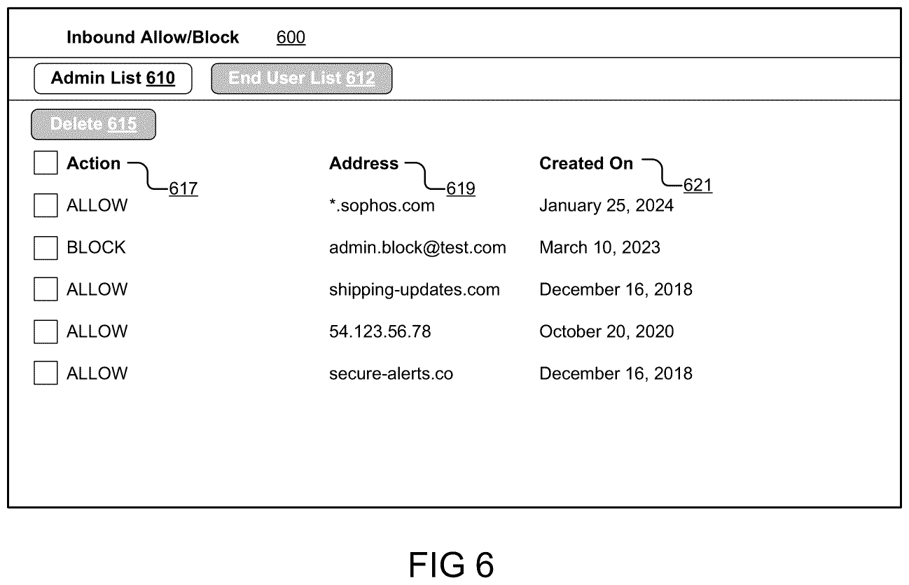

In some embodiments, the user interface 312 may include options for adding a sender header address and/or a sender envelope domain to an allowlist. Examples of the user interface are illustrated below with reference to FIGS. 6-8.

The threat detection tools 314 may implement any of the threat detection, algorithms, and techniques or the like described herein, or any other tools or the like useful for detecting threats or potential threats within an enterprise network. This may, for example, include signature-based tools, behavioral tools, machine learning models, and so forth. In general, the threat detection tools 314 may use event data provided by endpoints within the enterprise network, as well as any other available context such as network activity, heartbeats, and so forth to detect malicious software or potentially unsafe conditions for a network or endpoints connected to the network. In one aspect, the threat detection tools 314 may usefully integrate event data from a number of endpoints (including, e.g., network components such as gateways, routers, and firewalls) for improved threat detection in the context of complex or distributed threats. The threat detection tools 314 may also or instead include tools for reporting to a separate modeling and analysis platform 318, e.g., to support further investigation of security issues, creation or refinement of threat detection models or algorithms, review and analysis of security breaches, and so forth.

The threat management tools 316 may generally be used to manage or remediate threats to the enterprise network that have been identified with the threat detection tools 314 or otherwise. Threat management tools 316 may, for example, include tools for scanning, sandboxing, quarantining, removing, or otherwise remediating or managing malicious code or malicious activity, including email messages, e.g., using any of the techniques described herein.

The endpoint 302 may be any of the endpoints or other compute instances or the like described herein. This may, for example, include end-user computing devices, mobile devices, firewalls, gateways, servers, routers and any other computing devices or instances that might connect to an enterprise network. As described above, the endpoint 302 may generally include the security agent 306 that locally supports threat management on the endpoint 302, such as by monitoring for malicious activity, managing security components on the endpoint 302, maintaining policy compliance, and communicating with the threat management facility 308 to support integrated security protection as contemplated herein. The security agent 306 may, for example, coordinate instrumentation of the endpoint 302 to detect various event types involving various computing objects on the endpoint 302, and supervise logging of events in the data recorder 304. The security agent 306 may also or instead scan computing objects such as electronic communications or files, monitor behavior of computing objects such as executables, and so forth. The security agent 306 may, for example, apply signature-based or behavioral threat detection techniques, machine learning models (e.g. models developed by the modeling and analysis platform), or any other tools or the like suitable for detecting malware or potential malware on the endpoint 302.

The data recorder 304 may log events occurring on or related to the endpoint. This may, for example, include events associated with computing objects on the endpoint 302 such as file manipulations, software installations, and so forth. This may also or instead include activities directed from the endpoint 302, such as requests for content from Uniform Resource Locators (URLs) or other network activity involving remote resources. The data recorder 304 may record data at any frequency and any level of granularity consistent with proper operation of the endpoint 302 in an intended or desired manner.

The endpoint 302 may include the filter 322 to manage a flow of information from the data recorder 304 to a remote resource such as the threat detection tools 314 of the threat management facility 308. In this manner, a detailed log of events may be maintained locally on each endpoint, while network resources can be conserved for reporting of a filtered event stream that contains information believed to be most relevant to threat detection. The filter 322 may also or instead be configured to report causal information that causally relates collections of events to one another. In general, the filter 322 may be configurable so that, for example, the threat management facility 308 can increase or decrease the level of reporting based on a current security status of the endpoint, a group of endpoints, the enterprise network, and the like. The level of reporting may also or instead be based on currently available network and computing resources, or any other appropriate context.

In another aspect, the endpoint 302 may include the query interface 324. The query interface 324 may enable remote resources such as the threat management facility 308 to query the data recorder 304 remotely for information. This may include a request for specific events, activity for specific computing objects, or events over a specific time frame, or some combination of these. Thus for example, the threat management facility 308 may request all changes to the registry of system information for the past forty-eight hours, all files opened by system processes in the past day, all network connections or network communications within the past hour, or any other parametrized request for activities monitored by the data recorder 304. In another aspect, the entire data log, or the entire log over some predetermined window of time, may be request for further analysis at a remote resource.

It will be appreciated that communications among third party services 320, a threat management facility 308, and one or more endpoints such as the endpoint 302 may be facilitated by using consistent naming conventions across products and machines. For example, the system 300 may usefully implement globally unique device identifiers, user identifiers, application identifiers, data identifiers, Uniform Resource Locators, network flows, and files. The system may also or instead use tuples to uniquely identify communications or network connections based on, e.g., source and destination addresses and so forth.

According to the foregoing, a system disclosed herein includes an enterprise network, and endpoint coupled to the enterprise network, and a threat management facility coupled in a communicating relationship with the endpoint and a plurality of other endpoints through the enterprise network. The endpoint may have a data recorder that stores an event stream of event data for computing objects, a filter for creating a filtered event stream with a subset of event data from the event stream, and a query interface for receiving queries to the data recorder from a remote resource, the endpoint further including a local security agent configured to detect malware on the endpoint based on event data stored by the data recorder, and further configured to communicate the filtered event stream over the enterprise network. The threat management facility may be configured to receive the filtered event stream from the endpoint, detect malware on the endpoint based on the filtered event stream, and remediate the endpoint when malware is detected, the threat management facility further configured to modify security functions within the enterprise network based on a security state of the endpoint.

The threat management facility may be configured to adjust reporting of event data through the filter in response to a change in the filtered event stream received from the endpoint. The threat management facility may be configured to adjust reporting of event data through the filter when the filtered event stream indicates a compromised security state of the endpoint. The threat management facility may be configured to adjust reporting of event data from one or more other endpoints in response to a change in the filtered event stream received from the endpoint. The threat management facility may be configured to adjust reporting of event data through the filter when the filtered event stream indicates a compromised security state of the endpoint. The threat management facility may be configured to request additional data from the data recorder when the filtered event stream indicates a compromised security state of the endpoint. The threat management facility may be configured to request additional data from the data recorder when a security agent of the endpoint reports a security compromise independently from the filtered event stream. The threat management facility may be configured to adjust handling of network traffic at a gateway to the enterprise network in response to a predetermined change in the filtered event stream. The threat management facility may include a machine learning model for identifying potentially malicious activity on the endpoint based on the filtered event stream. The threat management facility may be configured to detect potentially malicious activity based on a plurality of filtered event streams from a plurality of endpoints. The threat management facility may be configured to detect malware on the endpoint based on the filtered event stream and additional context for the endpoint.

The data recorder may record one or more events from a kernel driver. The data recorder may record at least one change to a registry of system settings for the endpoint. The endpoints may include a server, a firewall for the enterprise network, a gateway for the enterprise network, or any combination of these. The endpoint may be coupled to the enterprise network through a virtual private network or a wireless network. The endpoint may be configured to periodically transmit a snapshot of aggregated, unfiltered data from the data recorder to the threat management facility for remote storage. The data recorder may be configured to delete records in the data recorder corresponding to the snapshot in order to free memory on the endpoint for additional recording.

### Computing Device

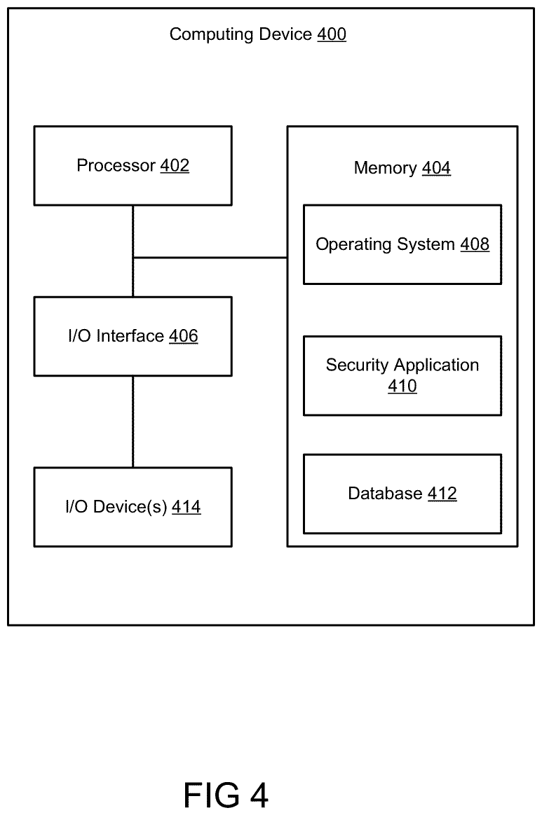

FIG. 4 is a block diagram of an example computing device 400 which may be used to implement one or more features described herein, in accordance with some implementations. The computing device 400 includes a processor 402, a memory 404, an input/output (I/O) interface 406, and one or more I/O devices 414 (e.g., display screen, touchscreen, display goggles or glasses, audio speakers, microphone, etc.). In some embodiments, memory 404 may include an operating system 408, a security application 410, and a database 412.

In some embodiments, computing device 400 may be part of a security management facility (e.g., 122 of FIG. 1), and perform appropriate method implementations described herein. Computing device 400 can be any suitable computer system, server, or other electronic or hardware device. For example, the computing device 400 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.).

Processor 402 can include one or more hardware processors and/or processing circuits to execute program code and control basic operations of the computing device 400. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 404 is typically provided in computing device 400 for access by the processor 402, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 402 and/or integrated therewith. Memory 404 can store software operating on the server computing device 400 by the processor 402, including the operating system 408, the security application or computer program product 410, and the database 412.

Memory 404 can include software instructions for executing the operations. Any of software in memory 404 can alternatively be stored on any other suitable storage location or computer-readable medium. In addition, memory 404 (and/or other connected storage device(s)) can store instructions and data used in the features described herein. Memory 404 and any other type of storage (magnetic disk, optical disk, magnetic tape, or other tangible media) can be considered “storage” or “storage devices.”

I/O interface 406 can provide functions to enable interfacing the server computing device 400 with other systems and devices. For example, network communication devices, storage devices, and input/output devices can communicate via interface 406. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 4 shows one block for each of processor 402, memory 404, I/O interface 406, software blocks 408, and 410, and database 412. These blocks may represent one or more processors or processing circuitries, operating systems, memories, I/O interfaces, applications, and/or software modules. In other implementations, computing device 400 may not have all of the components shown and/or may have other elements including other types of elements instead of, or in addition to, those shown herein.

A user device can also implement and/or be used with features described herein. Example user devices can be computer devices including some similar components as the computing device 400, e.g., processor(s) 402, memory 404, and I/O interface 406. An operating system, software and applications suitable for the client device can be provided in memory and used by the processor. The I/O interface for a user device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 414, for example, can be connected to (or included in) the computing device 400 to display images, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

### Security Application

Email protection involving detection of spam email messages, phishing email messages, emails with malicious attachments, emails that include links to malicious URLs, etc. Such detection may result in one or more of false negatives and false positives. False negatives occur when a suspicious email message is determined to be safe and is delivered to a recipient. A security application 410 may reduce instances of false negatives by allowing the user to add suspicious senders to a blocklist. False positives occur when an email message is determined to have suspicious content, even though the email message is safe. The security application 410 may reduce instances of false positives by allowing a user to mark a sender as trusted and add the sender to an allowlist.

Attackers may attempt to leverage the presence of an allowlist that includes trusted senders by spoofing the sender data in an email. Message to match a trusted sender to facilitate an exploitable attack by bypassing email protection. Conventionally, Sender Policy Framework (SPF) addresses this issue by performing an SPF check on every email message. However, the SPF check presents a problem where a user adds a sender header address to an allowlist, but the SPF check determines whether a sender envelope address is on the allowlist.

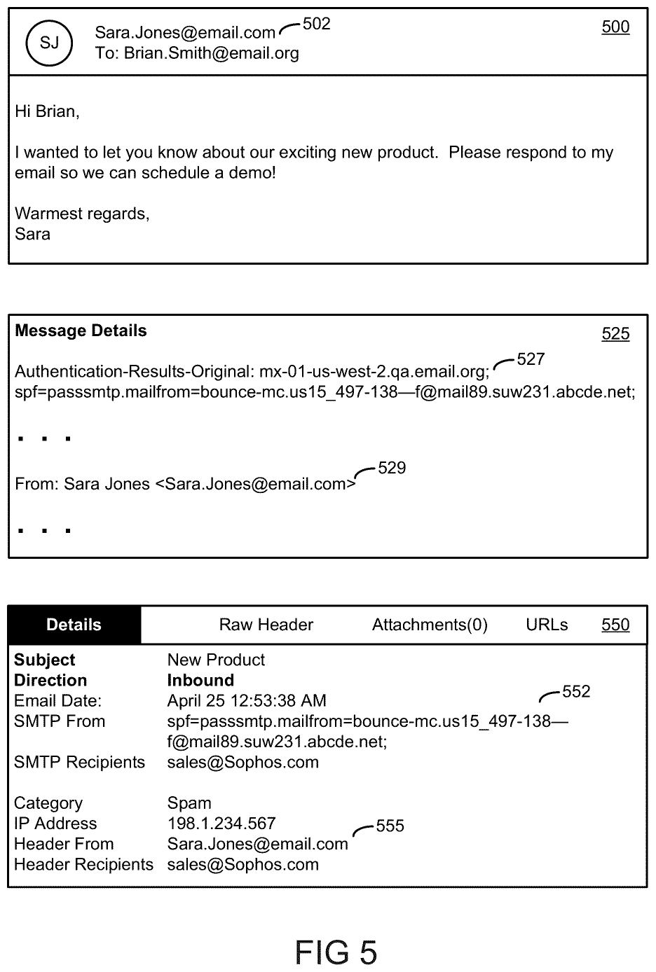

The sender envelope address is often different from the sender header address. The sender envelope address may change from one email to another and may often include undecipherable characters in the address. FIG. 5 illustrates an example of different types of information that are part of an email message, according to some embodiments described herein. The first example 500 is an email message received by an email application and displayed by a client interface. The sender header address 502 is for Sara.Jones@email.com.

The second example 525 includes message details corresponding to the email message in the first example 500. In the second example 525, the email message has passed the authentication check (i.e., Simple Mail Transfer Protocol (SMTP) From) based on the sender envelope address 527. The headers in the second example 525 also include a sender header address 529 that is the same as the sender header address 502 in the first example 500.

The third example 550 illustrates a portion of metadata from the email message. The metadata includes the sender envelope address 527 (SMTP From) and the sender header address 529 (Header From). The two email addresses are different, including a difference in the email domain. The sender envelope address 527 includes characters that are not user friendly because the sender envelope address 527 is not meant to be displayed in the client in email client applications that recipients use to view email messages.

The security application 410 uses SPF while additionally reducing the risk of false positives and false negatives, by enabling both sender header addresses and sender envelope domains to be added to an allowlist. For example, if a recipient authorizes the addition of a sender header address to an allowlist associated with the recipient, the security application 410 also adds the sender envelope domain to the allowlist. As a result, the email message recipient is not burdened with having to approve a sender multiple times, while also ensuring that email messages are safely delivered to recipients.

In some embodiments, the security application 410 receives an email message addressed to a recipient. The email message includes a sender header address and a sender header envelope address. The security application 410 determines whether the sender header address is on an allowlist associated with the recipient. The allowlist is stored in an allowlist datastore. The datastore may be part of the database 412 associated with computing device 400 or may be stored apart from the computing device 400, such as on a separate server (e.g., that is associated with the security application 410). Each recipient is associated with an allowlist. If an email message is sent to multiple recipients, the security application 410 determines whether the sender header address is on the allowlist for each of the recipients. If the sender header address is on a first allowlist associated with a first recipient but is not on a second allowlist associated with a second recipient, the email message is processed differently for each of the recipients. For example, the email message may be delivered to the first recipient, but not the second recipient.

If the sender header address is on the allowlist associated with the recipient, the security application 410 determines whether the sender envelope domain associated with the sender envelope address is on the allowlist. Each sender header address is associated with one or more sender envelope domains that are also part of the allowlist. If the sender envelope domain is on the allowlist, the security application 410 performs an SPF check on the email message. If the email message passes the SPF check, the security application 410 delivers the email message to the recipient. If the email message does not pass the SPF check, the security application 410 performs a protective action. The protective action may include quarantining the email message, delivering the email message to a sandbox, notifying an administrator that the email message has the suspicious content, removing an attachment from the email message, filtering the suspicious content, redacting the suspicious content, and/or adding a warning to the email message.

If the sender header address is not on the allowlist associated with the recipient, the security application 410 provides the email message to one or more scanners to detect whether the email message includes suspicious content. If the sender header address is on the allowlist associated with the recipient, the security application 410 determines whether a sender envelope domain associated with the sender envelope address is on the allowlist. If the sender envelope domain is not on the allowlist, the email message is provided to one or more scanners. The one or more scanners may be part of the security application 410 or separate. For example, the one or more scanners may be stored on one or more separate servers.

One scanner may handle all content associated with the email message or the scanners may be specialized and handle different kinds of content. In some embodiments, each scanner detects different kinds of suspicious content. For example, the types of content may include malicious attachments, such as viruses; email messages that contain Uniform Resource Locators (URLs) that link to malicious websites, such as phishing attempts that mimic other websites in order to capture users'passwords; email messages with senders that are spoofed so that email messages appear to come from a different sender than reality; email messages with content that contravenes policy, such as by disclosing confidential information, offensive email messages, or email messages containing personally identifiable data; email messages with attachments, such as executables; etc.

If the one or more scanners do not detect suspicious content, the security application 410 delivers the email message to the recipient. If one or more of the scanners detect suspicious content, the security application 410 performs a protective action. For example, the security application 410 may quarantine the email message, deliver the email message to a sandbox, notify an administrator that the email message has the suspicious content, remove an attachment from the email message, filter the suspicious content, redact the suspicious content, and/or add a warning to the email message.

After a protective action is performed, the security application 410 may delete the email message or deliver the email message. For example, if the protection action includes quarantine and/or sandboxing the email message, an administrator may review the email message and determine that the email message may be released. After the email message is released, the security application 410 delivers the email message.

After the security application 410 delivers the email message, the security application 410 determines whether the recipient requested to add the sender header address to the allowlist. In some embodiments, the security application 410 queries the allowlist datastore for the allowlist associated with the recipient and determines whether the sender header address is on the allowlist. If the sender header address is not on the allowlist, the security application 410 adds the sender header address and the sender envelope domain to the allowlist.

If the recipient did not request to add the sender header address to the allowlist, the security application 410 takes no further action. If the recipient requested to add the sender header address to the allowlist, the security application 410 determines whether the sender envelope domain is on the allowlist. If the sender envelope domain is not on the allowlist, the security application 410 adds the sender envelope domain to the allowlist. If the sender envelope domain is on the allowlist, the security application 410 takes no further action.

### Example User Interfaces

FIG. 6 illustrates an example user interface of an allowlist and blocklist that includes addresses, according to some embodiments described herein. The user interface 600 displays an admin list 610 of email addresses and IP addresses added by an administrator. The user interface 600 may display an end user list that includes email addresses and IP addresses added by a recipient by pressing the end user list button 612.

The user interface 600 includes three columns: an action column 617, an address column 619, and a created on column 621. By selecting any of the boxes in the action column 617, actions may be performed on a corresponding entry. For example, a user may delete an entry, edit an entry, etc.

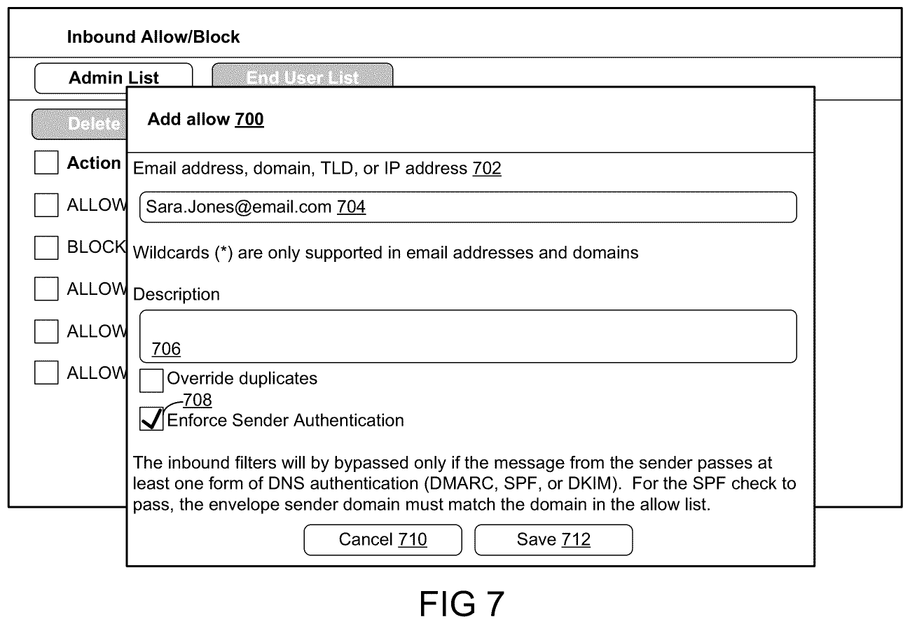

FIG. 7 is an example user interface 700 to add a sender header address to the allowlist illustrated in FIG. 6, according to some embodiments described herein. The user interface 700 includes a section for adding an email address, domain, Top Level Domain (TLD), or IP address 702 using a text field 704. In this example, Sara.Jones@email.com was added to the text field 704. In another example, the administrator may add an entire domain (e.g. Sophos.com) to the allowlist that applies to all mailboxes in the domain.

The user interface 700 includes a text field 706 for adding a description to the entry. A user may select a checkbox 708 to request that email messages associated with the sender are subjected to at least one form of DNS authentication including Domain-based Message Authentication (DMARC), SPF, or DomainKeys Identified Mail (DKIM). Once a user has completed the fields, the user may press a cancel button 710 (to cancel the modification) or a save button 712 (to save the modification to the allowlist).

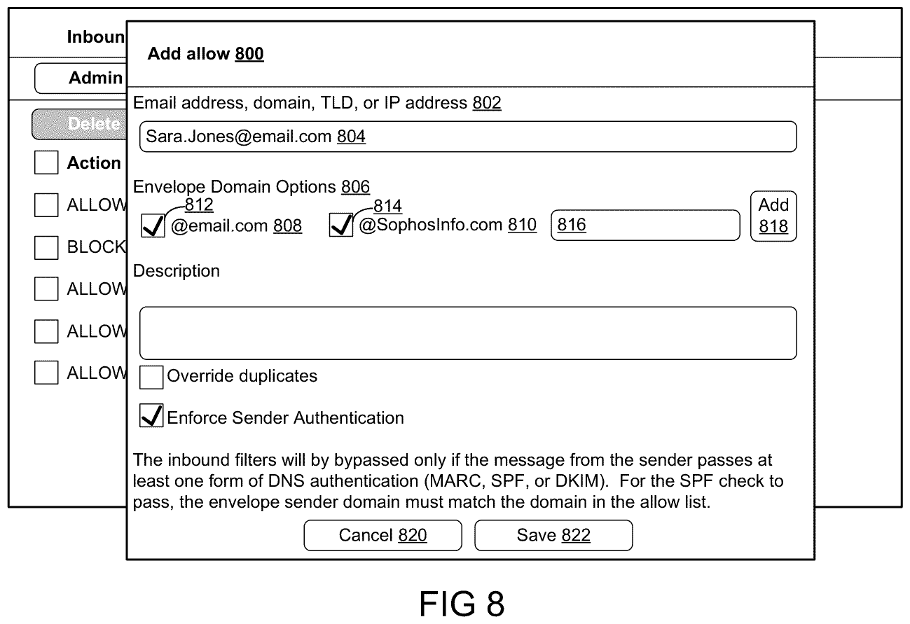

FIG. 8 is an example user interface 800 to add a sender header address and one or more sender email domains to the allowlist illustrated in FIG. 6, according to some embodiments described herein. The user interface 800 includes a section for adding a sender header address in the form of an email address, domain, Top Level Domain (TLD), or IP address 802 using a text field 804.

The user interface 800 includes envelope domain options 806 that are associated with the sender header address. In some embodiments, a security application 410 identifies a first domain 808 (“email.com”) and a second domain 810 (“SophosInfo.com”) that are associated with an email message. The user may add the envelope domains by checking the corresponding boxes 812, 814. The envelope domain options 806 include a text field 816 for manually entering a domain. Once the user is done, the user may select the add button 818 to add the domain and optionally add additional domains. Once a user has completed the form, the user may press a cancel button 820 (to discard their edits to the allowlist) or a save button 822 (to save their edits to the allowlist).

### Example Methods

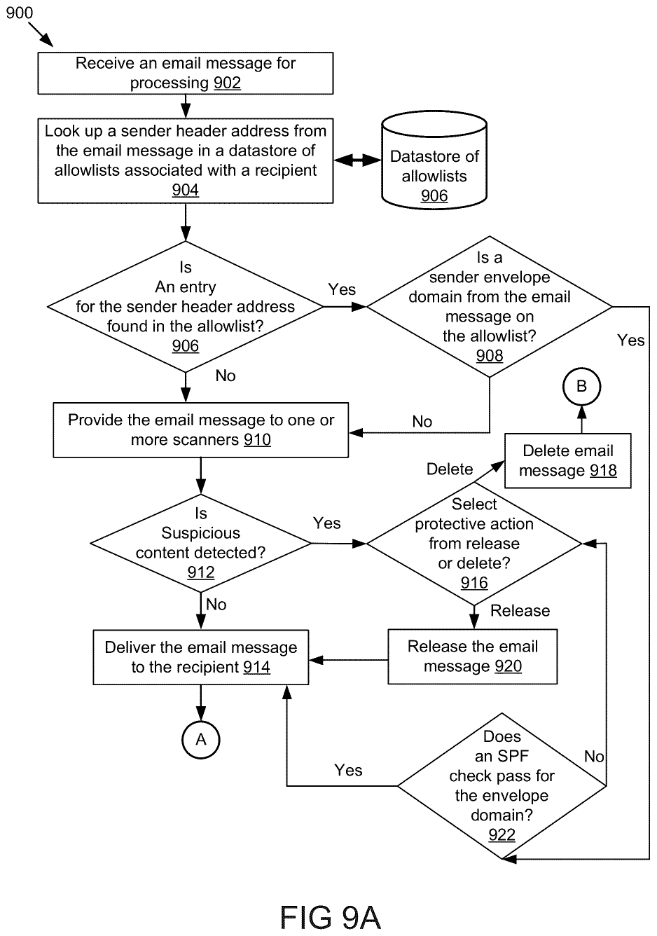

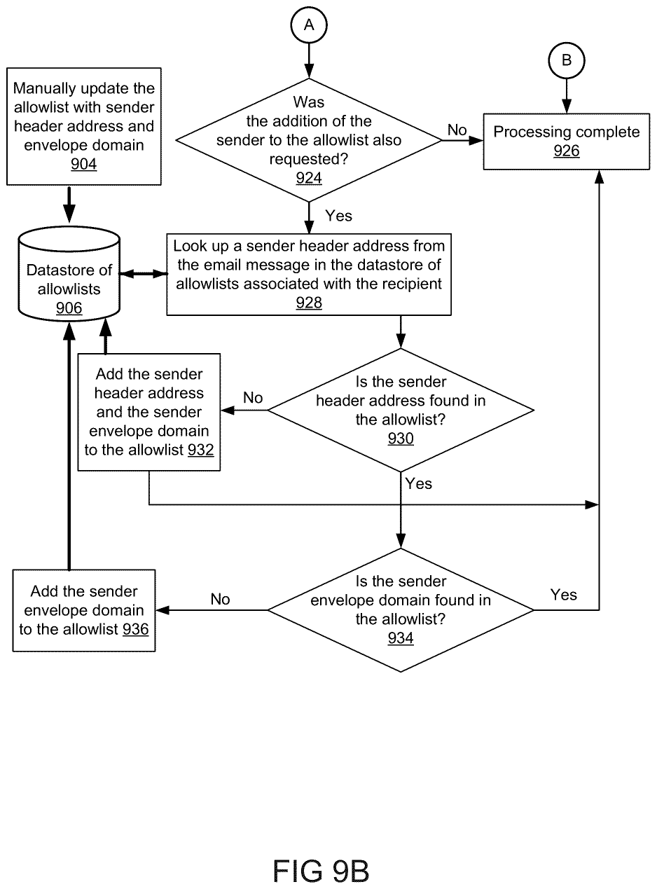

FIGS. 9A-9B are a flow diagram of an example method 900 to determine whether to deliver an email message, according to some embodiments described herein. The method 900 may be performed by the threat management facility 122 of FIGS. 1 and 2, the threat management facility 308 of FIG. 3, and/or the security application 410 of FIG. 4.

The method 900 may begin at block 902. At block 902, an email message is received for processing. Block 902 may be followed by block 904.

At block 904, a sender header address from the email message is looked up in a particular allowlist associated with a recipient allowlist from a datastore of allowlists 906. In case of the email message having multiple recipients, respective allowlists may be looked up for each recipient. In such cases, the datastore may store a separate allowlist for each recipient. Block 904 may be followed by block 906.

At block 906, it is determined whether an entry for the sender header address is found in the allowlist. Responsive to the entry for the sender header address not being found in the allowlist, block 906 may be followed by block 910. Responsive to the entry for the sender header address being found in the allowlist, block 906 may be followed by block 908.

At block 908, it is determined whether a sender envelope domain from the email message is on the allowlist. Responsive to the sender envelope domain from the email message being on the allowlist, block 908 may be followed by block 922. Responsive to the sender envelope domain from the email message not being on the allowlist, block 908 may be followed by block 910.

At block 910, the email message is provided to one or more scanners. Block 910 may be followed by block 912.

At block 912, it is determined whether the one or more scanners detected suspicious content. Responsive to the one or more scanners detecting suspicious content, block 912 is followed by block 916. Response to the one or more scanners not detecting suspicious content, block 912 may be followed by block 914.

At block 914, the email message is delivered to the recipient. Block 914 may be followed by a step illustrated in FIG. 9B as indicated by the “A” in FIG. 9A.

At block 916, responsive to suspicious content being detected, it is determined whether a protective action is to release or delete the email message. Other protective actions are possible and may be performed in addition to releasing or deleting the email message, such as quarantining the email message, delivering the email message to a sandbox, notifying an administrator that the email message has the suspicious content, removing an attachment from the email message, and/or filtering the suspicious content, redacting the suspicious content. Depending on the type of protective action, block 916 may be followed by block 918 or 920.

At block 918, the email message is deleted. The email message may be deleted, for example, if the email message is sent to a sandbox where it is determined that the email message constitutes a threat and cannot be delivered. Block 918 may be followed by block 926 in FIG. 9B. At block 926, processing is complete.

At block 920, the email message is released. The email message may be released, for example, if the protective action is quarantine, an administrator reviews the email message, and determines that the email message does not include suspicious content. Block 920 may be followed by block 914, where the email message is delivered to the recipient.

At block 922, it is determined whether an SPF check passes for the envelope domain. If the SPF check passes, block 922 may be followed by block 914. If the SPF check does not pass, block 922 may be followed by block 916.

Responsive to delivering the email message to the recipient at block 914 in FIG. 9A, block 914 is followed by block 924 in FIG. 9B. At block 924, it is determined whether the addition of the sender to the allowlist was also requested. In some embodiments, block 924 does not occur unless an allowlist for the sender header address was not found in block 906. Responsive to the addition of the sender to the allowlist not being requested, block 924 may be followed by block 926. At block 926, the processing is complete. Responsive to the addition of the sender to the allowlist being requested, block 924 may be followed by block 928.

At block 928, a sender header address is looked up from the email message in the datastore of allowlists 906 associated with the recipient. Block 928 may be followed by block 930.

At block 930, it is determined whether the sender header address is found in the allowlist. Responsive to the sender header address not being found in the allowlist, block 930 may be followed by block 932. At block 932, the sender header address and the sender header domain are added to the allowlist. Responsive to the sender header address not being found in the allowlist, block 930 may be followed by block 934.

At block 934, it is determined whether the sender envelope domain is found in the allowlist. Responsive to the sender envelope domain not being found in the allowlist, block 934 may be followed by block 936. Responsive to the sender envelope domain being found in the allowlist, block 934 may be followed by block 926 where the processing is complete.

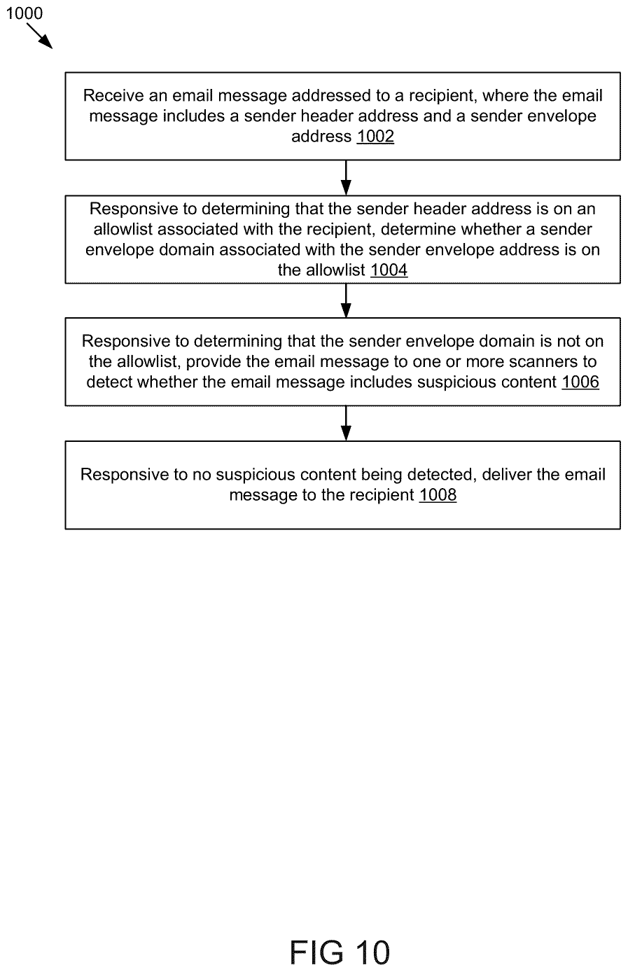

FIG. 10 is a flow diagram of an example method 1000 to selectively deliver an email message to a recipient, according to some embodiments described herein. The method 900 may be performed by the threat management facility 122 of FIGS. 1 and 2, the threat management facility 308 of FIG. 3, and/or the security application 410 of FIG. 4.

The method 1000 may begin with block 1002. At block 1002, an email message addressed to a recipient is received where the email message includes a sender header address and a sender envelope address. Block 1002 may be followed by block 1004.

At block 1004, responsive to determining that the sender header address is on an allowlist associated with the recipient, it is determined whether a sender envelope domain associated with the sender envelope address is on the allowlist. Responsive to the sender envelope domain being on the allowlist, the method 1000 may further include performing an SPF check on the email message, wherein delivering the email message to the recipient is performed only if the SPF check passes. If the SPF check does not pass, the method 1000 may further include performing an action selected from a group of quarantining the email message, delivering the email message to a sandbox, notifying an administrator that the email message has the suspicious content, removing an attachment from the email message, filtering the suspicious content, redacting the suspicious content, and combinations thereof. Block 1004 may be followed by block 1006.

At block 1006, responsive to determining that the sender envelope domain is not on the allowlist, the email message is provided to one or more scanners to detect whether the email message includes suspicious content. Responsive to suspicious content being detected, the method may further include performing a protective action selected from a group of quarantining the email message, delivering the email message to a sandbox, notifying an administrator that the email message has the suspicious content, removing an attachment from the email message, filtering the suspicious content, and/or redacting the suspicious content. Block 1006 may be followed by block 1008.

At block 1008, responsive to no suspicious content being detected, the email message is delivered to the recipient.

In some embodiments, the method 1000 further includes responsive to delivering the email message, determining whether the recipient requested to add the sender header address to the allowlist and responsive to determining that the recipient requested to add the sender header address to the allowlist, determining whether the sender envelope domain is on the allowlist. Responsive to determining that the sender envelope domain is not on the allowlist, the method 1000 may further include adding the sender envelope domain to the allowlist. In some embodiments, the method 1000 includes providing a user interface to the recipient to add the sender envelope domain to the allowlist.

In some embodiments, the email message is further addressed to a second recipient and the method further includes determining that the email message is trusted by the second recipient based on the sender header address being on a second allowlist associated with the second recipient and the sender envelope domain associated with the sender envelope address being on the second allowlist and responsive to determining that the email message is trusted by the second recipient, delivering the email message to the second recipient.

Various embodiments described herein perform automated computer-based analysis of email messages, including message content and metadata. Such automated analysis is performed with explicit user permission, in compliance with applicable laws and regulations. No content is shared with a third-party or reviewed by a human, other than those authorized by users. For example, the described techniques may be implemented in a security platform that performs automated scanning and threat mitigation. The security platform is configurable and may include various privacy settings. The security platform may be implemented by an email recipient organization, such as an organization (company, university, non-profit, government, etc.) and/or an email service provider. Email messages and/or features extracted from email messages may be stored and utilized in accordance with user-permitted settings.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMs, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
receiving an email message addressed to a recipient, wherein the email message includes a sender header address and a sender envelope address;
responsive to determining that the sender header address is on an allowlist associated with the recipient, determining whether a sender envelope domain associated with the sender envelope address is on the allowlist;
responsive to determining that the sender envelope domain is not on the allowlist, providing the email message to one or more scanners to detect whether the email message includes suspicious content; and
responsive to no suspicious content being detected, delivering the email message to the recipient.

2. The method of claim 1, further comprising:
responsive to delivering the email message, determining whether the recipient requested to add the sender header address to the allowlist; and
responsive to determining that the recipient requested to add the sender header address to the allowlist, determining whether the sender envelope domain is on the allowlist.

3. The method of claim 2, further comprising:
responsive to determining that the sender envelope domain is not on the allowlist, adding the sender envelope domain to the allowlist.

4. The method of claim 1, further comprising:
responsive to the sender envelope domain being on the allowlist, performing a Sender Policy Framework (SPF) check on the email message, wherein delivering the email message to the recipient is performed only if the SPF check passes.

5. The method of claim 1, further comprising:
responsive to the sender envelope domain being on the allowlist, performing a Sender Policy Framework (SPF) check on the email message; and
responsive to the SPF check not passing, performing an action selected from a group of quarantining the email message, delivering the email message to a sandbox, notifying an administrator that the email message has the suspicious content, removing an attachment from the email message, filtering the suspicious content, redacting the suspicious content, and combinations thereof.

6. The method of claim 1, further comprising:
responsive to suspicious content being detected, performing a protective action selected from a group of quarantining the email message, delivering the email message to a sandbox, notifying an administrator that the email message has the suspicious content, removing an attachment from the email message, filtering the suspicious content, redacting the suspicious content, and combinations thereof.

7. The method of claim 1, wherein the email message is further addressed to a second recipient, and further comprising:
determining that the email message is trusted by the second recipient based on the sender header address being on a second allowlist associated with the second recipient and the sender envelope domain associated with the sender envelope address being on the second allowlist; and
responsive to determining that the email message is trusted by the second recipient, delivering the email message to the second recipient.

8. The method of claim 1, further comprising providing a user interface to the recipient to add the sender envelope domain to the allowlist.

9. A device comprising:
one or more processors; and
one or more computer-readable media, coupled to the one or more processors and having instructions stored thereon that, when executed by the one or more processors, cause the one or more processors to perform operations comprising:
receiving an email message addressed to a recipient, wherein the email message includes a sender header address and a sender envelope address;
responsive to determining that the sender header address is on an allowlist associated with the recipient, determining whether a sender envelope domain associated with the sender envelope address is on the allowlist;
responsive to determining that the sender envelope domain is not on the allowlist, providing the email message to one or more scanners to detect whether the email message includes suspicious content; and
responsive to no suspicious content being detected, delivering the email message to the recipient.

10. The device of claim 9, wherein the operations further include:
responsive to delivering the email message, determining whether the recipient requested to add the sender header address to the allowlist; and
responsive to determining that the recipient requested to add the sender header address to the allowlist, determining whether the sender envelope domain is on the allowlist.

11. The device of claim 10, wherein the operations further include:
responsive to determining that the sender envelope domain is not on the allowlist, adding the sender envelope domain to the allowlist.

12. The device of claim 9, wherein the operations further include:
responsive to the sender envelope domain being on the allowlist, performing a Sender Policy Framework (SPF) check on the email message, wherein delivering the email message to the recipient is performed only if the SPF check passes.

13. The device of claim 9, wherein the operations further include:
responsive to the sender envelope domain being on the allowlist, performing a Sender Policy Framework (SPF) check on the email message; and
responsive to the SPF check not passing, performing an action selected from a group of quarantining the email message, delivering the email message to a sandbox, notifying an administrator that the email message has the suspicious content, removing an attachment from the email message, filtering the suspicious content, redacting the suspicious content, and combinations thereof.

14. The device of claim 9, wherein the operations further include:
responsive to suspicious content being detected, performing a protective action selected from a group of quarantining the email message, delivering the email message to a sandbox, notifying an administrator that the email message has the suspicious content, removing an attachment from the email message, filtering the suspicious content, redacting the suspicious content, and combinations thereof.

15. The device of claim 9, wherein the email message is further addressed to a second recipient and the operations further include:
determining that the email message is trusted by the second recipient based on the sender header address being on a second allowlist associated with the second recipient and the sender envelope domain associated with the sender envelope address being on the second allowlist; and
responsive to determining that the email message is trusted by the second recipient, delivering the email message to the second recipient.

16. A non-transitory computer-readable medium with instructions stored thereon that, responsive to execution by a processing device, causes the processing device to perform operations comprising:
receiving an email message addressed to a recipient, wherein the email message includes a sender header address and a sender envelope address;
responsive to determining that the sender header address is on an allowlist associated with the recipient, determining whether a sender envelope domain associated with the sender envelope address is on the allowlist;
responsive to determining that the sender envelope domain is not on the allowlist, providing the email message to one or more scanners to detect whether the email message includes suspicious content; and
responsive to no suspicious content being detected, delivering the email message to the recipient.

17. The non-transitory computer-readable medium of claim 16, wherein the operations further include:
responsive to delivering the email message, determining whether the recipient requested to add the sender header address to the allowlist; and
responsive to determining that the recipient requested to add the sender header address to the allowlist, determining whether the sender envelope domain is on the allowlist.

18. The non-transitory computer-readable medium of claim 17, wherein the operations further include:
responsive to determining that the sender envelope domain is not on the allowlist, adding the sender envelope domain to the allowlist.

19. The non-transitory computer-readable medium of claim 16, wherein the operations further include:
responsive to the sender envelope domain being on the allowlist, performing a Sender Policy Framework (SPF) check on the email message, wherein delivering the email message to the recipient is performed only if the SPF check passes.

20. The non-transitory computer-readable medium of claim 16, wherein the operations further include:
responsive to the sender envelope domain being on the allowlist, performing a Sender Policy Framework (SPF) check on the email message; and
responsive to the SPF check not passing, performing an action selected from a group of quarantining the email message, delivering the email message to a sandbox, notifying an administrator that the email message has the suspicious content, removing an attachment from the email message, filtering the suspicious content, redacting the suspicious content, and combinations thereof.
